(19) United States
(12) Patent Application Publication
(10) Pub. No.: US 2009/0037162 A1
(43) Pub. Date: Feb. 5, 2009

(54) DATACENTER WORKLOAD MIGRATION

(76) Inventors: Blaine D. Gaither, Fort Collins, CO (US); Russ W. Herrell, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/831,541

(22) Filed: Jul. 31, 2007

(51) Int. Cl. G06F 17/50

(52) U.S. Cl. 703/18

(57) ABSTRACT

A method is provided for evaluating workload migration from a target computer in a datacenter. The method includes tracking the number of power cycles occurring for a plurality of computers located within the datacenter and generating power cycling information as a result of the tracking. The method further includes determining whether to power cycle the target computer based on the power cycling information.

### BACKGROUND

Datacenters with several servers or computers having variable workloads on each of the machines may wish to migrate workloads from an under utilized machine to a more utilized machine. The decision to migrate the workload may be based upon any number of reasons, including for example, a desire to save power, relocate the workload to an area in the datacenter offering better cooling or ventilation, or to reduce cost on leased hardware.

As a result of the workload migration, the server or computer that the workload migrated from is powered-down during or subsequent to the migration period and later powered-up when additional resources are needed. The powering up and down (power cycling) process is very stressful on the server or computer hardware. For example, power cycling creates thermal stresses between the PCB board and packages soldered to the board. The result of power cycling can include broken solder connections, creating failures in the server or computer. Servers and computers are designed to withstand a finite number of power cycles during their design life. Exceeding the finite number of power cycles causes server or computer failures, driving up warranty costs for the computer or server components, including but not limited to, expensive IO boards.

### BRIEF DESCRIPTION OF THE DRAWINGS

FIG. 1 illustrates one example embodiment of a datacenter structured for workload migration.

FIG. 2 illustrates an example embodiment of a general purpose computer system.

FIG. 3 illustrates the example embodiment of FIG. 1 in which a workload is migrated from a first computer to a second computer.

FIG. 4 illustrates an example embodiment of a datacenter structured for workload migration.

FIG. 5 illustrates a flow diagram of an embodiment employing power awareness migration management for workload migration from a computer.

FIG. 6 illustrates an alternative embodiment employing power awareness migration management for workload migration from a computer.

### DETAILED DESCRIPTION

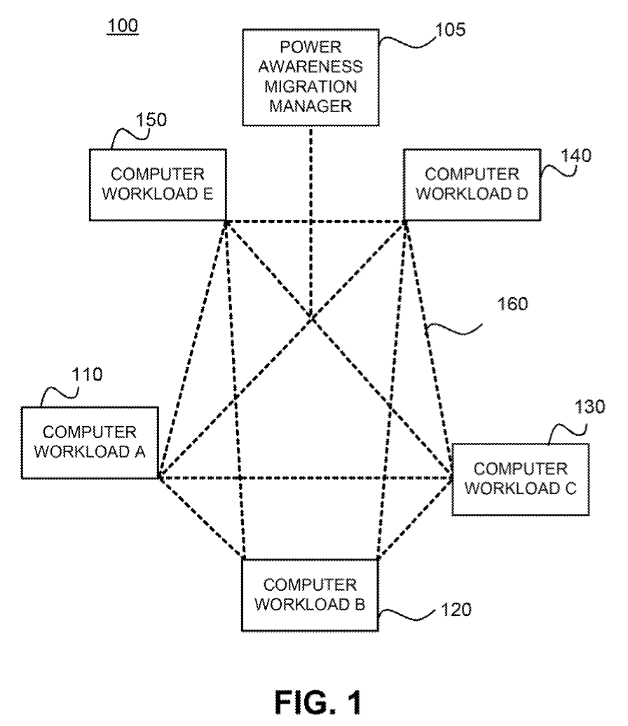

With reference now to the figures, and in particular with reference to FIG. 1, there is depicted a datacenter 100 utilizing power awareness migration management through a power awareness migration manager 105 between a plurality of computers 110-150. The power awareness migration manager 105 can be a stand alone component or distributed among the plurality of computers 110-150 in the datacenter.

Power cycling the computers from which the workload has been migrated results in undesirable thermal stresses on the computer's hardware. As a result, the thermal stresses created by power cycling produce failures in the computers' hardware or components. In large datacenters, the same computers may be continuously targeted as migration candidates. Excessive power cycling may void warranties on the computers or their system components.

In order to mitigate the thermal stresses imposed by power cycling and the computer failures resulting therefrom, systems and methods of power awareness migration management is provided for a datacenter. In a very general description, the power awareness migration manager 105 causes the workload migration to be more evenly spread across several, if not all of the computers in the datacenter. The power awareness migration manager 105 may in some cases however, prevent migration from occurring based on for example, the number of power cycles already experienced by a target computer.

The computers 110-150 are in communication with each other by wired or wireless communication links 160. While the term computers is being used throughout, it is intended that the term is, and remains synonymous with central processing units (CPUs), workstations, servers, and the like and is intended throughout to encompass any and all of the examples referring to computers discussed herein and shown in each of the figures.

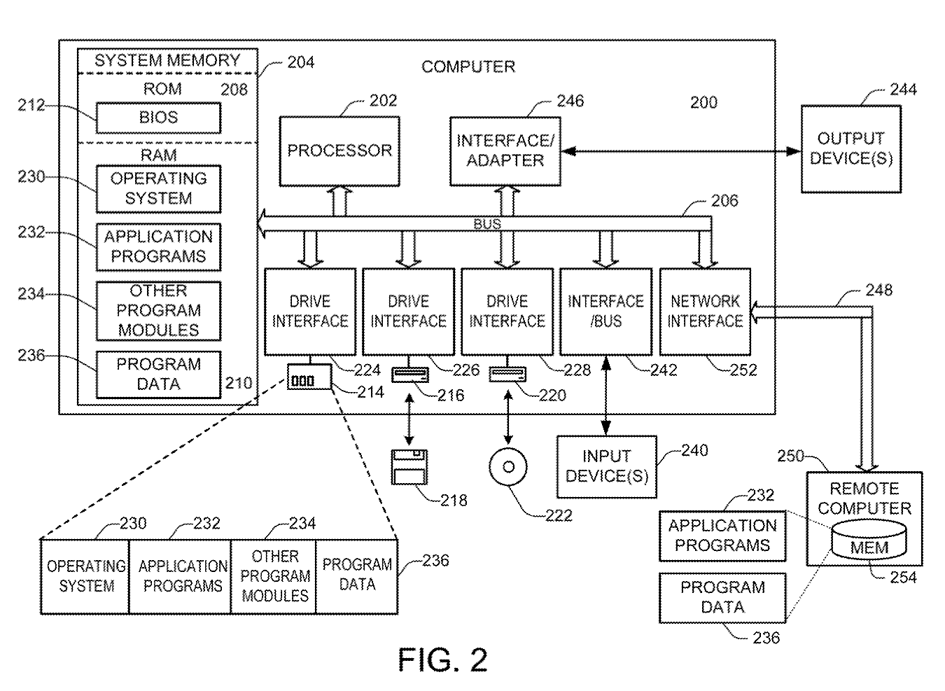

FIG. 2 illustrates in more detail, any one or all of the plurality of computers 110-150 in an example of an individual computer system 200 that can be employed to implement systems and methods described herein, such as based on computer executable instructions running on the computer system. The computer system 200 can be implemented on one or more general purpose networked computer systems, embedded computer systems, routers, switches, server devices, client devices, various intermediate devices/nodes and/or stand alone computer systems. Additionally, the computer system 200 can be implemented as part of a network analyzer or associated design tool running computer executable instructions to perform methods and functions, as described herein.

The computer system 200 includes a processor 202 and a system memory 204. A system bus 206 couples various system components, including the system memory 204 to the processor 202. Dual microprocessors and other multi-processor architectures can also be utilized as the processor 202. The system bus 206 can be implemented as any of several types of bus structures, including a memory bus or memory controller, a peripheral bus, and a local bus using any of a variety of bus architectures. The system memory 204 includes read only memory (ROM) 208 and random access memory (RAM) 210. A basic input/output system (BIOS) 212 can reside in the ROM 208, generally containing the basic routines that help to transfer information between elements within the computer system 200, such as a reset or power-up.

The computer system 200 can include a hard disk drive 214, a magnetic disk drive 216, e.g., to read from or write to a removable disk 218, and an optical disk drive 220, e.g., for reading a CD-ROM or DVD disk 222 or to read from or write to other optical media. The hard disk drive 214, magnetic disk drive 216, and optical disk drive 220 are connected to the system bus 206 by a hard disk drive interface 224, a magnetic disk drive interface 226, and an optical drive interface 228, respectively. The drives and their associated computer-readable media provide nonvolatile storage of data, data structures, and computer-executable instructions for the computer system 200. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital video disks and the like. A number of program modules may also be stored in one or more of the drives as well as in the RAM 210, including an operating system 230, one or more application programs 232, other program modules 234, and program data 236.

A user may enter commands and information into the computer system 200 through user input device 240, such as a keyboard, a pointing device (e.g., a mouse). Other input devices may include a microphone, a joystick, a game pad, a scanner, a touch screen, or the like. These and other input devices are often connected to the processor 202 through a corresponding interface or bus 242 that is coupled to the system bus 206. Such input devices can alternatively be connected to the system bus 206 by other interfaces, such as a parallel port, a serial port or a universal serial bus (USB). One or more output device(s) 244, such as a visual display device or printer, can also be connected to the system bus 206 via an interface or adapter 246.

The computer system 200 may operate in a networked environment using logical connections 248 (representative of the communication links 160 in FIG. 1) to one or more remote computers 250 (representative of any of the plurality of computers 110-150 in FIG. 1). The remote computer 250 may be a workstation, a computer system, a router, a peer device or other common network node, and typically includes many or all of the elements described relative to the computer system 200. The logical connections 248 can include a local area network (LAN) and a wide area network (WAN).

When used in a LAN networking environment, the computer system 200 can be connected to a local network through a network interface 252. When used in a WAN networking environment, the computer system 200 can include a modem (not shown), or can be connected to a communications server via a LAN. In a networked environment, application programs 232 and program data 236 depicted relative to the computer system 200, or portions thereof, may be stored in memory 254 of the remote computer 250.

Each of the computer systems 200 in the plurality of computers 110-150 of the datacenter 100 may be running different or similar operating systems and/or applications. Further, each of the computers 110-150 may include a workload varying in size. For example, computers 110 and 130 include Workload A and Workload C, respectively acting as web servers, computer 120 includes Workload B acting as a print server, and computer 150 includes Workload E acting as an application server.

Various reasons arise that make it desirable to migrate the workload from one computer to another computer in the datacenter 100. Such reasons to migrate the workload from one computer to another include, costs savings relating to the reduction in power, elimination of under utilized computers, relocate the workload to a computer 110-150 in the datacenter 100 having better ventilation or cooling, or reduce costs on expensive or leased computers.

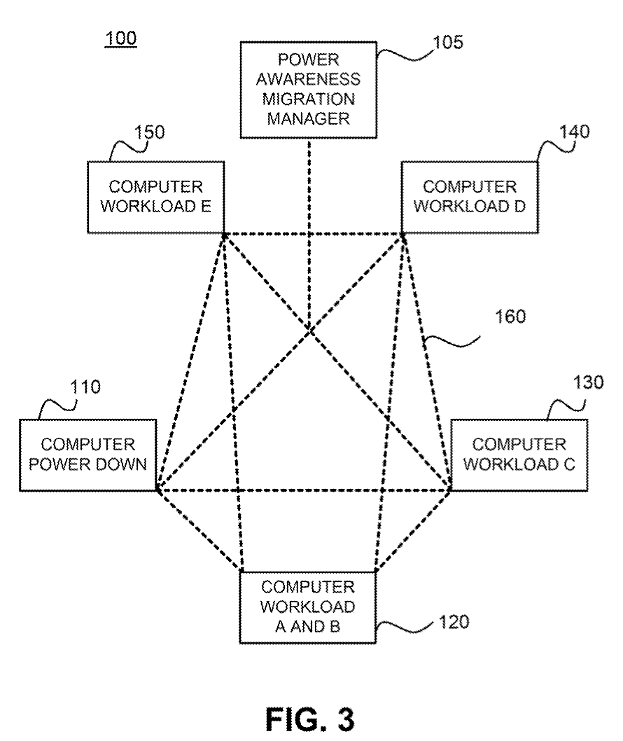

The workload migration may be achieved by many different means, including conventional means such as physically transferring the workload from one computer to another or more modern means such as a migration of guest operating systems from one hypervisor (also referred to as a virtual machine monitor) to another. For example, computer 110 is identified as a candidate for workload migration and as a result, Workload A is migrated from computer 110 to a more utilized computer 120, as illustrated in FIG. 3. Subsequent to the workload migration, computer 110 is powered-down to conserve energy and/or to reduce heat in the datacenter 100.

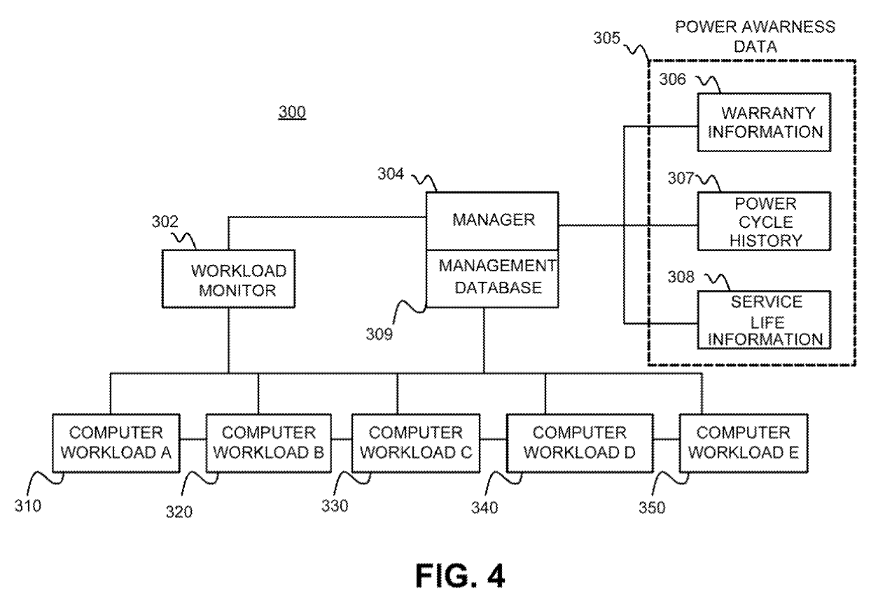

FIG. 4 illustrates a datacenter 300 employing power awareness migration management in which a workload monitor 302 is used. The workload monitor 302 tracks the number of power cycles that occurs on the computers located within the datacenter 300. A manager 304 evaluates the tracking information provided by the monitor 302 and compares it with power awareness data 305. The power awareness data 305 can include any combination of warranty information 306, power cycle history 307, and service life data 308 for each of the computers in the datacenter 300 represented by 310-350 in FIG. 4.

The monitor 302 can be centrally located on any of the computers 310-350 in the datacenter 300, distributed between the computers in the datacenter, or located in a remote computer (not shown) outside of the datacenter. Similarly, the manager 304 can be centrally located on any of the computers 310-350 in the datacenter 300, distributed between the computers in the datacenter, or located in a remote computer (not shown) outside of the datacenter, and/or on the same or different computer as the monitor 302.

The monitor 302 may interrogate the computers in the datacenter 300 to acquire the power cycling information. Alternatively, the monitor 302 may include workload management software that tracks the power cycling information for each of the computers in the datacenter. The tracking information is compiled by the manager 304 in a management database 309.

Also compiled by the manager 304 in the management database 309 is the power awareness data 305, which includes warranty information 306, power cycle history 307, and service life information 308. The service life information 308 includes the power cycling life design specifications for each of the computers in the datacenter 300, as well as hardware reliability information compiled from outside information and/or internal failure information generated by the monitor 302 based on past performances of similar computers. Once a computer in the datacenter is targeted for migration for ancillary reasons, for example, power savings, cooling, and/or under utilization, the manager 304 employs power awareness migration management to decide whether the target computer is a viable candidate for migration based on the information compiled in the management database 309.

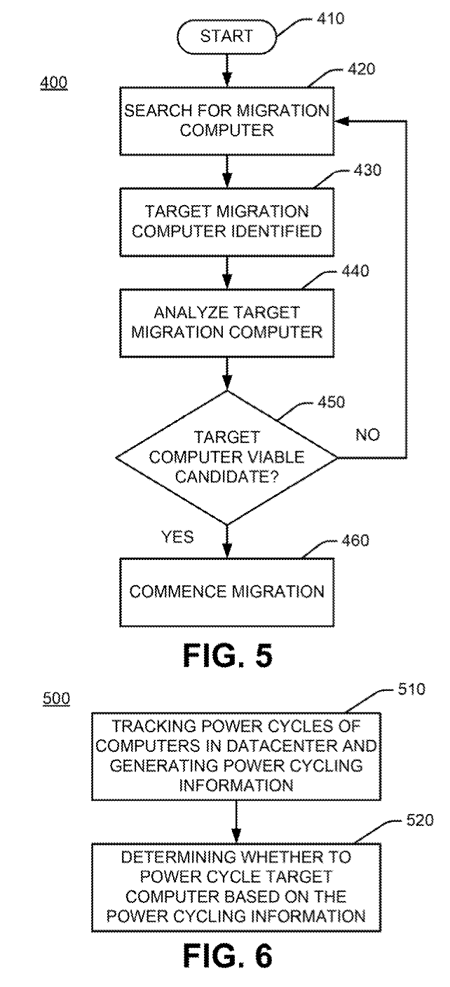

FIG. 5 illustrates a flow diagram of a power awareness migration management methodology 400 to determine whether a target computer in a datacenter is a viable migration candidate. The power awareness migration management methodology 400 can be generated from computer readable media, such as software or firmware residing in the computer, hardware based from discrete circuitry such as an application specific integrated circuit (AISC), or any combination thereof.

The methodology starts at 410 wherein a hypervisor, manager 304, or human desires to migrate workloads from target computers in a datacenter. At 420, a search for a migration computer is commenced. At 430, the target computer is identified. The target computer is selected based on for example, the target computer's high power consumption, heat production, and/or under utilization. At 440, the target computer is analyzed. The analysis includes an evaluation of the power cycle history 307 that is acquired by an interrogation by the monitor 302 or measuring software internal to the manager 304. The evaluation is against, for example, warranty information 306, service life information 308, and/or compares the power cycle history 307 with the number of power cycles on the remaining computers in the datacenter. The evaluation at 440 could also be performed against predefined thresholds as to the number of power cycles permitted or a variable threshold that changes as the power cycles or computers change in the datacenter. At 450, a determination is made as to whether the target computer is a viable candidate for migration based on the analysis at 440. If the decision is (NO), a new search for a migration computer is executed, or alternatively the methodology 400 terminates and no migration takes place. If the decision is (YES), the migration of the workload from the target computer commences at 460 and the target computer is powered-down upon completion of the migration.

The result of the decision at 450 can be used to update the management database 309, update the monitor 302 software, and/or utilize the monitor 302 software to provide reports of the decision and power cycling information. The software reports could be provided to the vendor or customer on the number of power cycles experienced by each computer in the datacenter and its status relative to the number of cycles that it is designed to handle over a period of time.

FIG. 6 illustrates a flow diagram of a power awareness migration management methodology 500. The methodology 500 is for evaluating workload migration from a target computer in a datacenter. At 510, a tracking of the number of power cycles occurs for a plurality of computers located within the datacenter and power cycling information is generated as a result of the tracking. At 520, a determination is made on whether to power cycle the target computer based on the power cycling information.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method for evaluating workload migration from a target computer in a datacenter, the method comprising:
tracking a number of power cycles occurring for a plurality of computers located within the datacenter and generating power cycling information as a result of the tracking; and
determining whether to power cycle the target computer based on the power cycling information.

2. The method of claim 1, wherein the determining further comprises comparing the power cycling information for the target computer with power cycling information relating to the other of the plurality of computers in the datacenter.

3. The method of claim 2, wherein the determining further comprises comparing the power cycling information against service life information relating to the target computer.

4. The method of claim 3, wherein the service life information comprises power cycling life design specifications relating to each of the computers in the datacenter.

5. The method of claim 3, wherein the service life information comprises power cycling life reliability information generated by a workload monitor centrally located on one of the computers in the datacenter.

6. The method of claim 2 wherein the determining further comprises comparing the power cycling information against warranty information relating to the target computer.

7. The method of claim 2, wherein the determining further comprises comparing the power cycling information against a prescribed threshold.

8. The method of claim 2, wherein the determining further comprises comparing the power cycling information against a variable threshold.

9. The method of claim 2, further comprising interrogating the target computer and the other of the plurality of computers in the datacenter in order to obtain the power cycling information.

10. A system for evaluating workload migration from a target computer in a datacenter, the system comprising:
a workload monitor that tracks the number of power cycles that occurs on computers located within the datacenter to form tracking information; and
a migration manager that evaluates whether the workload in the target computer should be migrated to another computer located within the datacenter based on the tracking information provided by the workload monitor.

11. The system of claim 10, further comprising a database having service life information relating to the computers located in the datacenter wherein the migration manager considers the service life information for the target computer in its evaluation of whether the workload in the target computer should be migrated.

12. The system of claim 11, wherein the service life information comprises power cycling life design specifications relating to each of the computers located in the datacenter.

13. The system of claim 11, wherein the service life information comprises power cycling life reliability information generated by the workload monitor.

14. The system of claim 10, wherein the workload monitor is centrally located on one of the computers in the datacenter.

15. The system of claim 10, wherein the migration manager is centrally located on one of the computers located in the datacenter.

16. The system of claim 10, further comprising a database having power cycling history relating to the computers located in the datacenter wherein the migration manager considers the power cycling history for the target computer in its evaluation of whether the workload in the target computer should be migrated.

17. The system of claim 10, further comprising a database having warranty information relating to the computers located in the datacenter wherein the migration manager considers the warranty information for the target computer in its evaluation of whether the workload in the target computer should be migrated.

18. The system of claim 17, wherein the database further comprises power cycling history and service life information relating to the computers located in the datacenter wherein the migration manager considers the warranty information, power cycling history, and service life information for the target computer against the other of the computers in the datacenter in its evaluation of whether the workload in the target computer should be migrated.

19. A computer readable medium having computer executable instructions for performing a method comprising:
tracking the number of power cycles occurring for a plurality of computers located within a datacenter and generating power cycling information as a result of the tracking;
analyzing the power cycling information relating to a target computer located within the datacenter;
comparing the power cycling information for the target computer with power cycling information relating to the other of the plurality of computers in the datacenter; and
determining whether to power cycle the target computer as a result of the comparison.

20. The computer readable medium having computer executable instructions for performing the method of claim 19, further comprising providing reports relating to the power cycling information.
